(19) United States
(12) Patent Application Publication
(10) Pub. No.: US 2024/0102978 A1
(43) Pub. Date: Mar. 28, 2024

(54) IMPROVED METHOD FOR POLYSACCHARIDE QUANTIFICATION

(71) Applicant: GLAXOSMITHKLINE BIOLOGICALS SA, Rixensart (BE)

(72) Inventors: Carlo Giannelli, Sienna (IT); Francesca Micoli, Sienna (IT); Maria Michelina Raso, Sienna (IT)

(21) Appl. No.: 17/996,103

(22) PCT Filed: Apr. 12, 2021
(86) PCT No.: PCT/EP2021/059370

§ 371 Date: Oct. 13, 2022

(30) Foreign Application Priority Data
Apr. 14, 2020 (EP) 20169341.3

(51) Int. Cl. G01N 30/88; G01N 1/40; G01N 30/06

(52) U.S. Cl. CPC G01N 30/88; G01N 1/4044; G01N 30/06; G01N 2001/4016; G01N 2030/8836; G01N 2333/255

(57) ABSTRACT

The present invention provides a method for measuring the concentration and/or amount of one or more polysaccharide in a test sample comprising or consisting of the steps of (a) acid hydrolysis of the test sample with hydrochloric acid and trifluoroaceticacid; (b) chromatographic separation of the hydrolysed test sample of step (a); and (c) determining the concentration and/or amount of the one or more polysaccharide based on the data generated in step (b), together with processed test samples and kit for use of the same.

### FIELD OF THE INVENTION

The present invention is directed to the identification and quantification of polysaccharide in a test sample and, in particular, polysaccharides comprising 2-amino uronic acid, such as certain bacterial polysaccharides.

### INTRODUCTION

Salmonella enterica serovar Typhi (S. Typhi) is the main cause of enteric fever, a systemic febrile illness, human restricted, mainly affecting infants and young children in South and South-East Asia¹. It has also become an increasing problem in sub-Saharan Africa² and large outbreaks have been reported in Oceania. There are an estimated 11 million cases of typhoid fever, with approximately 116,800 associated deaths per year globally³. Antibiotic resistance has become a major problem and multidrug-resistant isolates, often associated with the dominant H58 haplotype, are prevalent in parts of Asia and Africa^{4,5}.

Unconjugated Vi polysaccharide (Vi) is one of the two widely available licensed vaccines against typhoid fever, together with an oral live attenuated vaccine (Ty21a)⁶. Enteric coated tablets are licensed for adults and children over 5 years of age. Multiple doses are needed and there are issues of thermal stability. Vi is only licensed for children over two years of age, and is characterised by lack of immunological memory, affinity maturation and limited duration of antibody response⁷. To overcome these limitations, glycoconjugates of Vi polysaccharide with appropriate carrier proteins have been developed, which converts the T-independent Vi in a T-dependent antigen, enabling effective vaccination of infants. Recently, Vi glycoconjugate vaccines have been licensed in India and China^{7,8}. Typbar TCV conjugate vaccine has been recently pre-qualified by WHO and is currently in effectiveness trials in several countries^{9,10}. A Vi-CRM glycoconjugate vaccine is being developed by Biological E in India¹¹⁻¹³.

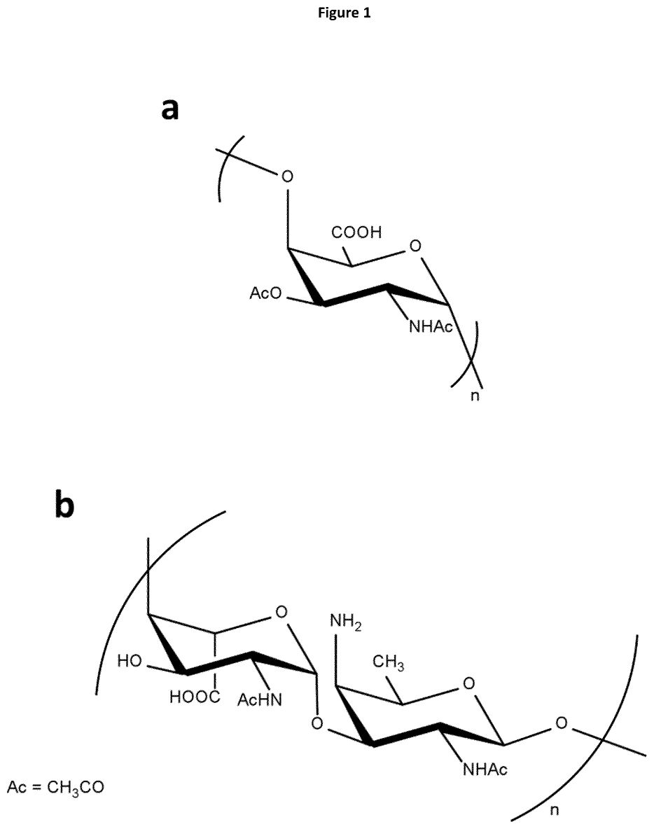

Manufacture of vaccines requires good characterisation and quality control of all its components. Vi content is a critical quality attribute of vaccines composed of conjugated or unconjugated Vi¹⁴ and a method for Vi quantification is fundamental for vaccine release, to monitor stability and to ensure appropriate immune response. Vi is a linear homopolymer of α-1,4-N-acetylgalactosaminouronic acid, O-acetylated at the C-3 position¹⁵ (FIG. 1a).

Colorimetric methods such as phenol-sulfuric acid or anthrone tests, commonly used for carbohydrates quantitative analysis do not work properly for Vi because of its resistance to acid hydrolysis¹⁶. This also prevented the application of traditional High-Performance Anion Exchange Chromatography-Pulsed Amperometric Detection (HPAEC-PAD) methods¹⁷⁻²¹ for Vi quantification.

The present inventors previously developed a quantification method based on strong alkaline hydrolysis followed by HPAEC-PAD analysis²². The method was used to quantify Vi both in unconjugated and conjugated samples; it was reproducible, simple and precise and more sensitive compared to other methods, such as Hestrin and acridine orange colorimetric methods^{16, 23} also applied to Vi quantification. Furthermore, it is suitable for quantifying Vi in complex matrixes and for analysis of formulated conjugates. However, the method is based on the quantification of an unknown species coming from polysaccharide degradation in alkaline conditions. Although the assay has utility, it makes the specificity of the assay sub-optimal, as for example the same hydrolysis applied to Shigella sonnei O-antigen, composed of repeating disaccharide units of O-[4-amino-2-(N-acetyl)amino-2,4-dideoxy-β-D-galactopyranosyl]-(1→4)-[2-(N-acetyl)amino-2-deoxy-α-L-altropyranuronic acid] (FIG. 1b), resulted in the formation of a species eluted with the same retention time as Vi, likely coming from degradation of the alturonic acid, detected by HPAEC-PAD²⁴.

### DESCRIPTION

Here, with the aim to improve sensitivity and specificity of the analysis, the present inventors have developed a novel method for polysaccharide (e.g., Vi) quantification, based on acid hydrolysis with concomitant use of trifluoroacetic and hydrochloric acids, reported for rapid protein hydrolysis²⁵, followed by HPAEC-PAD. A Design of Experiment (DoE) approach was used for identification of optimal hydrolysis conditions. The new method results in a more sensitive and specific assay, based on the detection of the completely de-acetylated Vi monomer. Accuracy and precision were also determined.

This new method will facilitate characterization of polysaccharide-based vaccines, such as Vi-based vaccines. The method can be used for quantification of other polysaccharides, including those resistant to common acid hydrolysis, as Shigella sonnei O-antigen, or containing 2-amino uronic acids, as Streptococcus pneumoniae serotype 12F and Staphylococcus aureus types 5 and 8 capsular polysaccharides.

Accordingly, a first aspect of the invention provides a method for measuring the concentration and/or amount of one or more polysaccharide in a test sample comprising the steps of:
a. acid hydrolysis of the test sample with hydrochloric acid and trifluoroacetic acid;
b. chromatographic separation of the hydrolysed test sample of step (a); and
c. determining the concentration and/or amount of the one or more polysaccharide based on the data generated in step (b).

Optionally, the one or more polysaccharides are identified by their chromatographic profiles in step (c). Optionally, prior to step (a) the method comprises a step of providing a test sample. Optionally, the method is also used to identify the one or more polysaccharide for quantification.

By ‘test sample’ we mean or include any polysaccharide-containing substance or mixture, for example, bacterial culture, intermediates of saccharide purification (e.g., from bacterial culture, drug substance or drug product), intermediates of conjugation, final conjugate, drug substance (e.g., vaccine drug substance) and drug product (e.g., vaccine drug product).

The chromatographic method of step (b) may be any suitable chromatography known in the art (see, for example, Nováková & Vic\check{k}ová, 2009, Analytica Chimica Acta, ‘A review of current trends and advances in modern bio-analytical methods: Chromatography and sample preparation’, 656(1-2): 8-35). Hence, alternatively or additionally, the chromatography is analytical chromatography, for example, column chromatography, gas chromatography or liquid chromatography (for example, HPLC [high-performance liquid chromatography] or HPAEC [high performance anion exchange chromatography]).

Alternatively or additionally, the method of any one of the preceding claims wherein the chromatography is HPAEC, for example, HPAEC-PED (high performance anion exchange chromatography with pulsed electrochemical detection) or HPAEC-PAD (high performance anion exchange chromatography with pulsed amperometric detection) see, for example, Rohrer, Basumallick & Hurum, 2013, Biochemistry (Moscow), ‘High-performance anion-exchange chromatography with pulsed amperometric detection for carbohydrate analysis of glycoproteins’ 78: 697-709. Alternatively or additionally, the HPAEC is preferably HPAEC-PAD.

Alternatively or additionally, the polysaccharide is a bacterial polysaccharide. Alternatively or additionally, the bacterial polysaccharide is surface polysaccharide, for example, a capsular polysaccharide or a lipopolysaccharide. For a review see Mostowy & Holt, 2018, Trends Microbiol., ‘Diversity-Generating Machines: Genetics of Bacterial Sugar-Coating’ 26(12): 1008-1021, which is incorporated by reference herein.

The method of any one of the preceding claims wherein the polysaccharide is resistant to common acid hydrolysis. By polysaccharide that is ‘resistant to common acid hydrolysis’ we mean or include polysaccharides that, when hydrolysed using a single acid selected from the group consisting of hydrofluoric acid, hydrochloric acid, or trifluoroacetic acid, results in monomer degradation before the polysaccharide is fully depolymerised. The extent of polysaccharide depolymerisation can be determined by any suitable means known in the art, for example, by HPLC-SEC, HPAEC-PAD, mass spectrometry, gas chromatography, gas chromatography-mass spectrometry (GC-MS), and nuclear magnetic resonance (NMR). E.g., see the methods utilised in reference 22, which is incorporated by reference herein.

By ‘monomer degradation’ we mean or include that the chemical structure of the monomer is altered by the acid hydrolysis. Monomer alteration can be determined by any suitable means known in the art, for example, using HPLC-SEC, HPAEC-PAD, mass spectrometry, gas chromatography, gas chromatography-mass spectrometry (GC-MS), and nuclear magnetic resonance (NMR) (e.g., by comparison with reference samples). E.g., see the methods utilised in reference 22.

By the polysaccharide is ‘fully depolymerised’ we mean or include that all or substantially all of the polysaccharide has been monomerised, for example, ≥90% has been monomerised, e.g., ≥91%, ≥92%, ≥93%, ≥94%, ≥95%, ≥96%, ≥97%, ≥98%, ≥99% or ≥100% of the polysaccharide has been monomerised.

Polysaccharide depolymerisation can be determined by any suitable means known in the art, for example, by comparison with reference samples using HPLC-SEC, HPAEC-PAD, mass spectrometry, gas chromatography, gas chromatography-mass spectrometry (GC-MS), and nuclear magnetic resonance (NMR).

Alternatively or additionally, the polysaccharide contains 2-amino uronic acid, for example, the polysaccharide may be selected from the group consisting of:
a. Vi capsular polysaccharide;
b. Shigella sonnei O-antigen;
c. Acinetobacter baumannii K1 capsular polysaccharide;
d. Streptococcus pneumoniae serotype 12A;
e. Streptococcus pneumoniae serotype 12F;
f. Staphylococcus aureus type 5 capsular polysaccharide;
g. Staphylococcus aureus type 8 capsular polysaccharide; and
h. Enterobacterial common antigen (ECA).

Alternatively or additionally, the polysaccharide comprises or consists of repeating disaccharide units of O-[4-amino-2-(N-acetyl)amino-2,4-dideoxy-β-D-galactopyranosyl]-(1→4)-[2-(N-acetyl)amino-2-deoxy-α-L-altropyranuronic acid]. Alternatively or additionally, the polysaccharide is preferably Vi capsular polysaccharide.

Alternatively or additionally, the acid hydrolysis step is performed with a concentration of hydrochloric acid and trifluoroacetic acid, to achieve at least 50% monomer recovery of the test sample polysaccharide(s), for example, at least 60%, 70%, 90%, 85%, 90%, 91%, 92%, 93%, 94%, 95%, 96%, 97%, 98%, 99% or 100% monomer recovery of the test sample polysaccharide(s).

Percentage monomer recovery can be determined by any suitable means known in the art, for example, by quantitative nuclear magnetic resonance (e.g., by comparison with control samples). E.g., see the methods utilised in reference 22.

Alternatively or additionally, the acid hydrolysis step results in no monomer degradation or substantially no monomer degradation.

By ‘no monomer degradation’ we mean or include that none of the polysaccharide monomer is structurally altered during the acid hydrolysis step (other than by depolymerisation). Alternatively or additionally, by ‘no monomer degradation’ we mean or include that none of the polysaccharide monomer is structurally altered during the acid hydrolysis step other than by depolymerisation and minor structural changes comprising or consisting of de-O-acetylation and de-N-acetylation (e.g., cleavage of ester and amide bonds).

For the avoidance of doubt, the monomer degradation can take place when the monomer is in its monomeric state or when the monomer forms part of an oligomer or polymer. By ‘substantially no sugar degradation’ we mean or include that ≤10% of the polysaccharide monomer is structurally altered during the acid hydrolysis step, for example, ≤9%, ≤8%, ≤7%, ≤6%, ≤5%, ≤4%, ≤3%, ≤2%, ≤1%, ≤0.5% or ≤0.1% of the polysaccharide monomer is structurally altered during the acid hydrolysis step. Monomer alteration can be determined by any suitable means known in the art, for example, using HPLC-SEC, HPAEC-PAD, mass spectrometry, gas chromatography, gas chromatography-mass spectrometry (GC-MS), and nuclear magnetic resonance (NMR) (e.g., by comparison with reference samples). E.g., see the methods utilised in reference 22.

The present inventors found that conventional alkaline hydrolysis of polysaccharides containing 2-amino uronic acids (Vi and Shigella sonnei O-antigen) led to the production of a chromatography peak common to the polysaccharides tested. In contrast, this common peak was absent from chromatograms of the same polysaccharides when hydrolysed using the methods of the present invention. Hence, the present method is capable of differentiating and quantifying polysaccharides containing 2-amino uronic acids.

Alternatively or additionally, in the present method, the acid hydrolysis step does not result in a HPAEC-PAD peak common to polysaccharides containing 2-amino uronic acids. Preferably, the acid hydrolysis step does not result in a peak common to two or more different polysaccharides containing different 2-amino uronic acids subjected to alkaline hydrolysis (in particular, a chromatography common to Vi and Shigella sonnei O-antigen).

Alternatively or additionally, the hydrochloric acid and trifluoroacetic acid of acid hydrolysis step (a) may be added sequentially, but preferably are added in admixture. Alternatively or additionally, the hydrochloric acid and trifluoroacetic acid are mixed to a concentration of:
a. 7M to 10M HCl (for example, 8M to 10M, 8M to 9M, or 8M HCl); and
b. 5% to 30% v/v TFA (for example, 10% to 25%, 10% to 20% or 10% TFA v/v TCA).

Alternatively or additionally, preferably, the acid hydrolysis step is not performed with <6M HCl.

Alternatively or additionally, the acid hydrolysis step is performed at 72.0° C. to 85.0° C., for example, 75.0° C. to 82.5° C., 77.5° C. to 82.5° C., or 80° C. Alternatively or additionally, preferably, the acid hydrolysis step is not performed at <70° C. or >90° C.

Alternatively or additionally, the acid hydrolysis step is performed for 3.5 to 6.0 hours, for example, 4.0 to 6.0 hours, 4.0 to 5.5 hours, 4.0 to 5.0 hours or 4.5 hours. Alternatively or additionally, preferably, the acid hydrolysis step is performed for at least 3 hours.

The method of any one of the preceding claims wherein chromatography step (b) is or uses HPAEC-PAD, and is run for ≤30 minutes, for example, ≤25 minutes, ≤20 minutes, ≤19 minutes, ≤18 minutes, ≤17 minutes, ≤16 minutes, ≤15 minutes, ≤14 minutes, ≤13 minutes, ≤11 minutes, ≤10 minutes or ≤9 minutes.

Alternatively or additionally, prior to acid hydrolysis step (a), the test sample is desalted and/or buffer exchanged, for example, by dialysis or gel filtration chromatography.

Alternatively or additionally, the method comprises or consists of the steps of:
i. optionally, desalting a test sample by gel filtration chromatography.
ii. mixing the test sample with TFA-HCl solution at a ratio of 0.3:1 v/v (for example, mixed by vortexing);
iii. heating the mixture of step (ii) at 80° C. for 4.5 hours;
iv. cooling the mixture of step (iii) to room temperature;
v. evaporating the mixture of step (iv) (for example, by nitrogen flush, such that the test sample is fully desiccated [e.g., at least 99% desiccated w/w, preferably 99.5%, 99.6%, 99.7%, 99.8%, 99.9%, 99.99% desiccated w/w]);
vi. dissolving the mixture of step (v) in water (for example, 300 ml of water and dissolved by, for example, vortexing);
vii. filtering the mixture of step (vi) through a 0.2 m filter; and
viii. performing HPAEC-PAD on the mixture of step (vii).

Chromatography data may be interpreted using predefined standards, for example, one or more measurement from previous experiments and/or standard curves generated therefrom. Alternatively or additionally, in step (c), the concentration and/or amount of the one or more polysaccharide is determined by comparison with chromatographic measurements of one or more control sample.

Alternatively or additionally, the one or more control samples comprise predetermined concentrations and/or amounts of a polysaccharide to be measured in the test sample. Alternatively or additionally, the one or more control sample(s) is(are) subjected to the same sample preparation, acid hydrolysis and chromatographic steps as the test sample.

Alternatively or additionally, sample preparation, acid hydrolysis and chromatographic steps of the test sample are performed concurrently with, or consecutive to, the sample preparation, acid hydrolysis and chromatographic steps of the one or more control sample.

Alternatively or additionally, a sufficient number and/or concentration range of control samples of differing concentrations to provide a line of best fit is used, for example, a line of best fit that results in (a) a significant regression model, (b) a non-significant lack of fit, and (c) residuals normally distributed (e.g., without the need for data transformation). Alternatively or additionally, the line of best fit has a coefficient of determination (R²) of at least 0.60, for example, at least 0.70, 0.75, 0.80, 0.85, 0.90, 0.95, 0.96, 0.97, 0.98, 0.99 or 1.00. Alternatively or additionally, the line of best fit is normally distributed, for example, the residuals having a Kolmogorov-Smirnov, or Ryan-Joiner test with a P>0.1 (see, for example, Ryan, T. A. and Joiner B. L. (1976): Normal Probability Plots and Tests for Normality, Technical Report, Statistics Department, The Pennsylvania State University, which is incorporated by reference herein).

Alternatively or additionally, the following concentration of polysaccharide in the one or more control sample is 0.05 to 15 μg/mL, for example, 0.05, 0.08 0.10, 0.15, 0.16, 0.31, 0.62, 1.25, 2.5, 5 and 10 μg/mL. Alternatively or additionally, the concentration of polysaccharide in the one or more control sample is 5.0 to 10 μg/mL.

Alternatively or additionally, the chromatographic run order of the test and/or control samples is randomised. In one embodiment, the test and control samples are run in triplicate, quadruplet or quintuplet repeats.

By ‘control sample’ we mean or include the monomer(s) resulting from acid hydrolysis of a polysaccharide to be measured and/or the purified polysaccharide itself (which may be subjected to an acid hydrolysis step of the invention).

Alternatively or additionally, the method can be used to quantify samples containing less than 2.5 ug/mL of the polysaccharide to be quantified, for example, less than 2.0 ug/mL, less than 1.5 ug/mL, less than 1 ug/mL, less than 0.5 ug/mL, less than 0.25 ug/mL, less than 0.20 ug/mL or less than 0.1 ug/mL of the polysaccharide to be quantified.

A second aspect of the invention provides a test sample prepared using the acid hydrolysis step defined in the method of the first aspect.

A third aspect of the invention provides a kit for performing the method defined in the first aspect comprising (a) hydrochloric acid, (b) trifluoroacetic acid, (c) optionally, one or more control sample as defined in any one of claims 20-28, and (d) optionally, instructions for use

Preferred, non-limiting examples which embody certain aspects of the invention will now be described, with reference to the following tables and figures.

FIG. 1: Vi polysaccharide (a) and S. sonnei O-antigen (b) repeating unit structures.

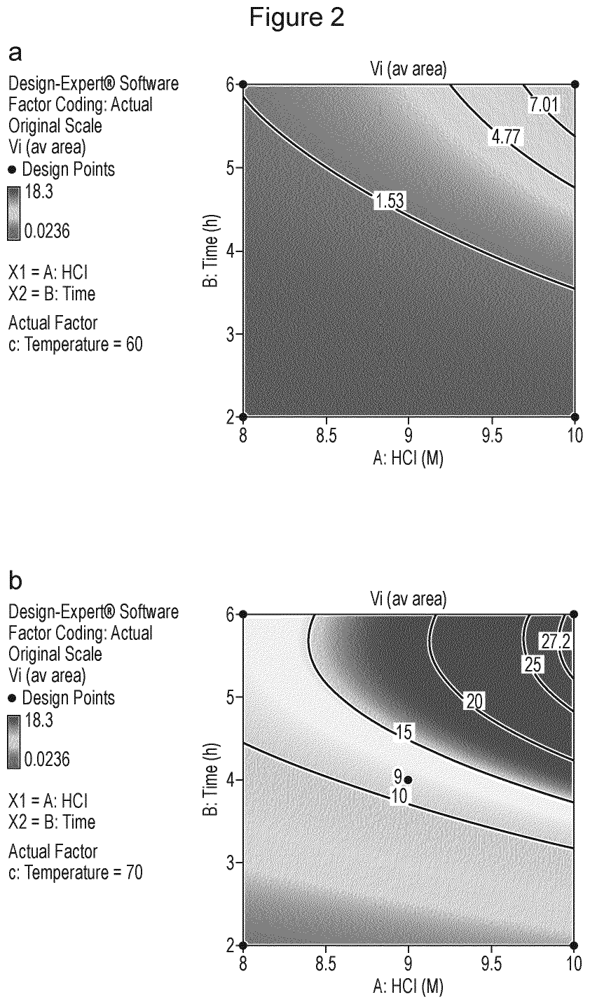

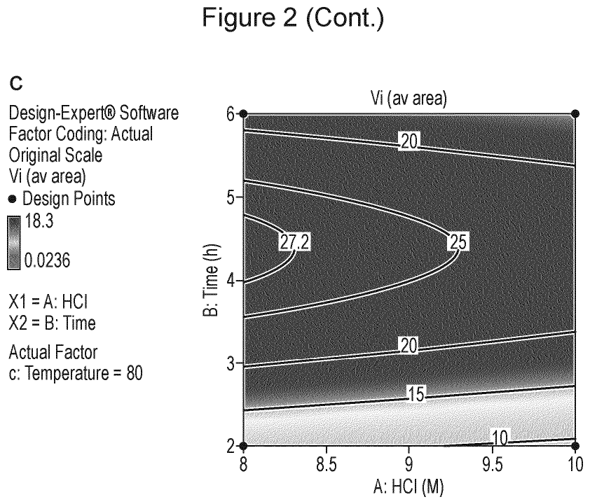

FIG. 2: Identification of optimal hydrolysis conditions for Vi quantification by acid hydrolysis followed by HPAEC-PAD: response surface plots at temperature of 60° C. (a), 70° C. (b) and 80° C. (c) from DOE experiment.

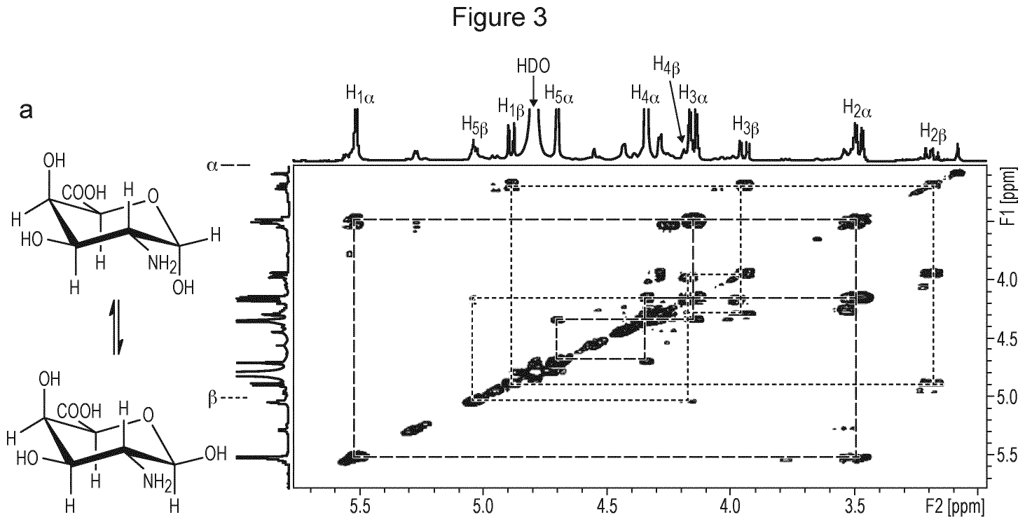

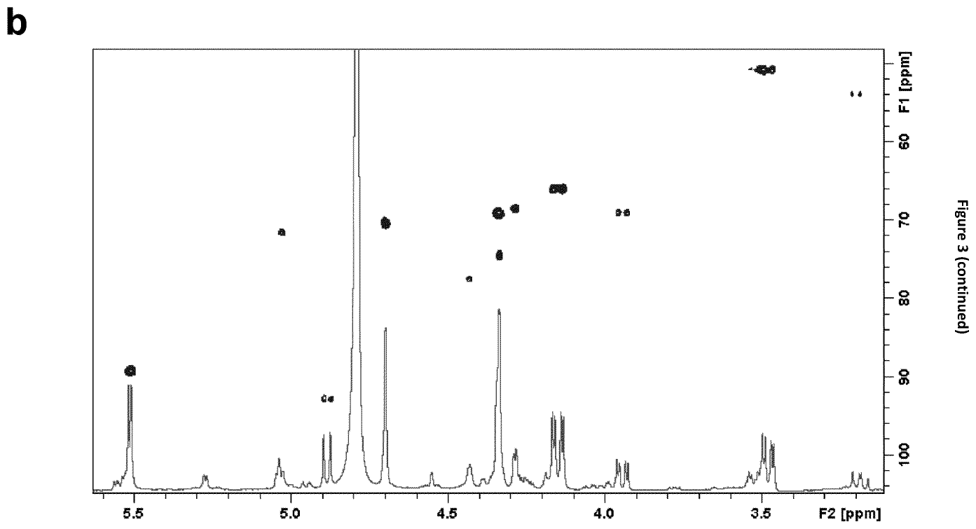

FIG. 3: COSY (a), HSQC (b), MS spectrum (c) of the monomer coming from Vi polysaccharide hydrolyzed with HCl/TFA in the optimal conditions identified.

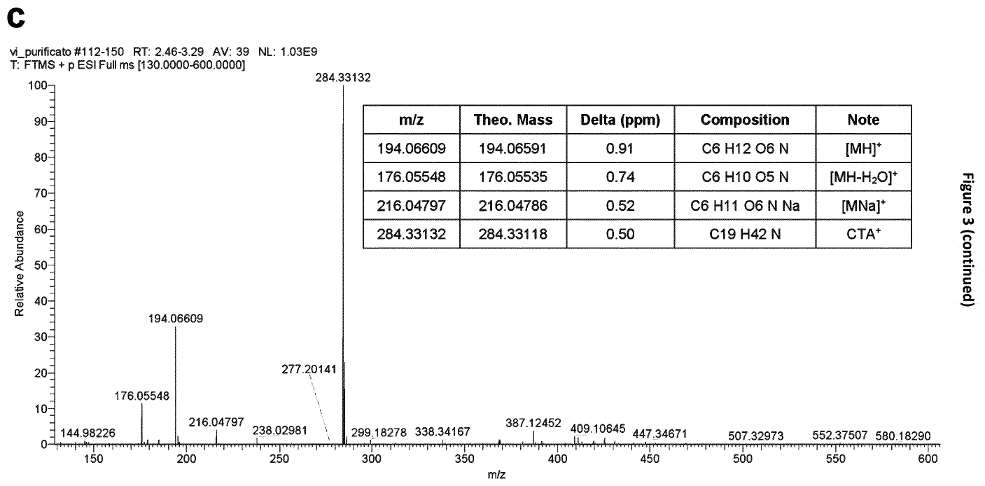

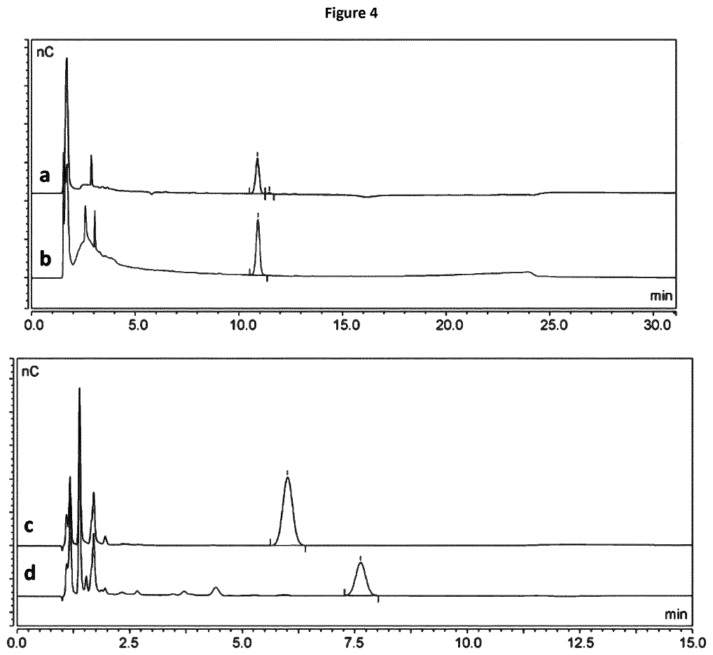

FIG. 4: HPAEC-PAD chromatograms after alkaline hydrolysis of Vi polysaccharide (a) or S. sonnei O-antigen (b), and after HCl/TFA hydrolysis of Vi polysaccharide (c) or S. sonnei O-antigen (d).

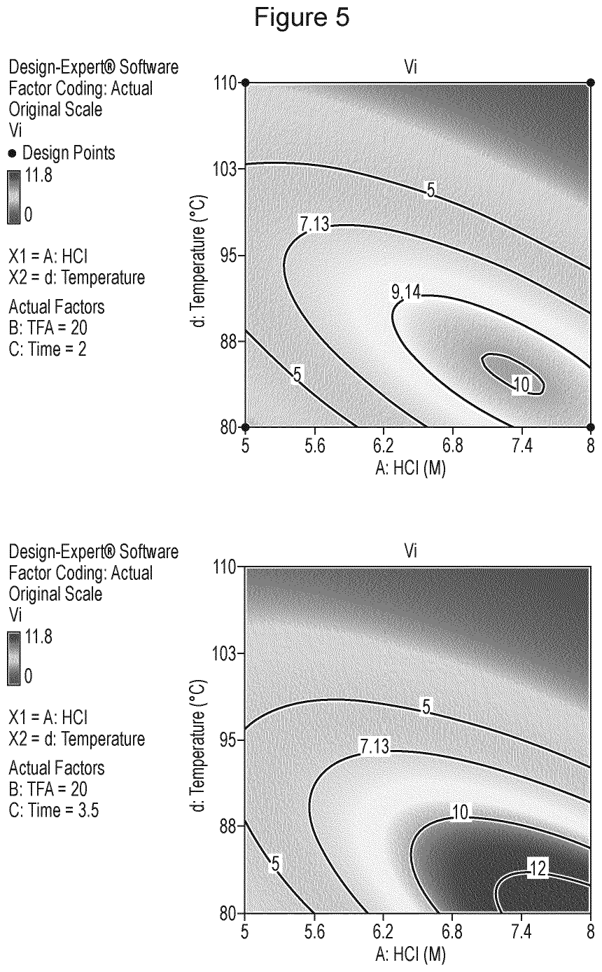

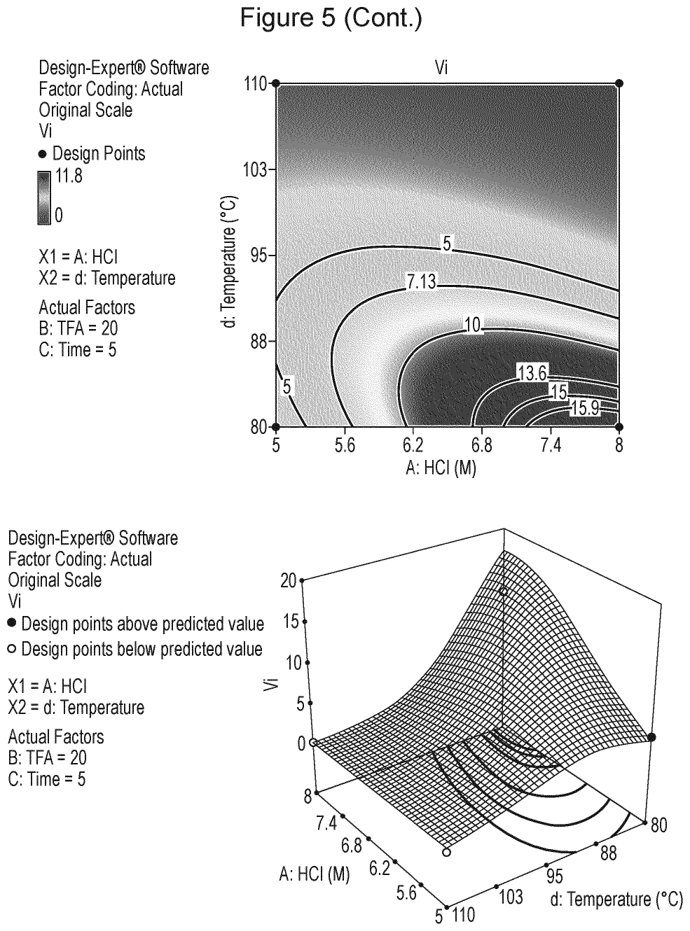

FIG. 5. Identification of optimal hydrolysis conditions for Vi quantification by acid hydrolysis followed by HPAEC-PAD: first DOE response surface.

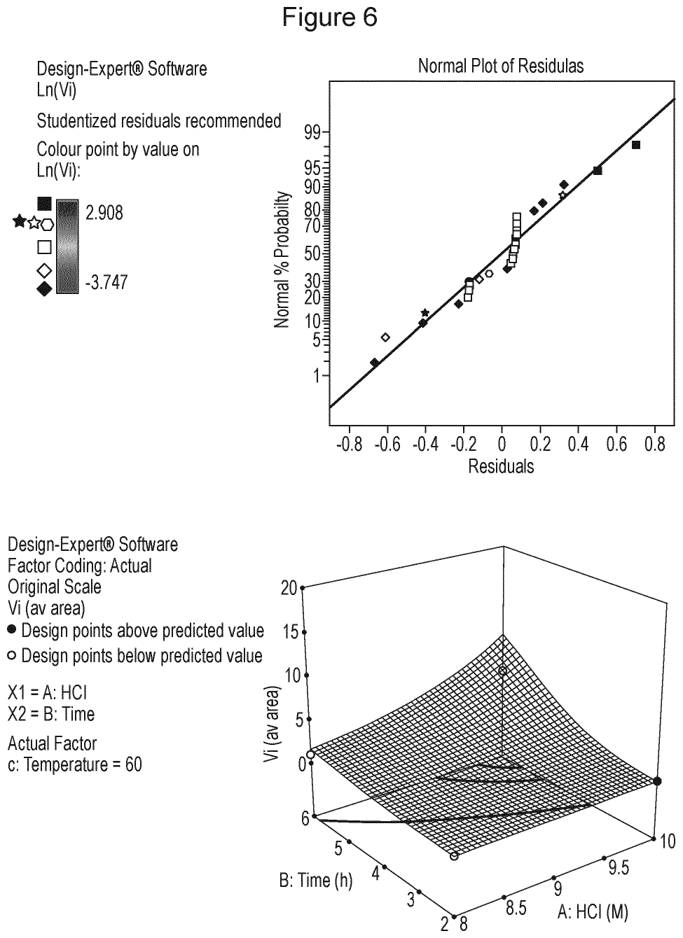

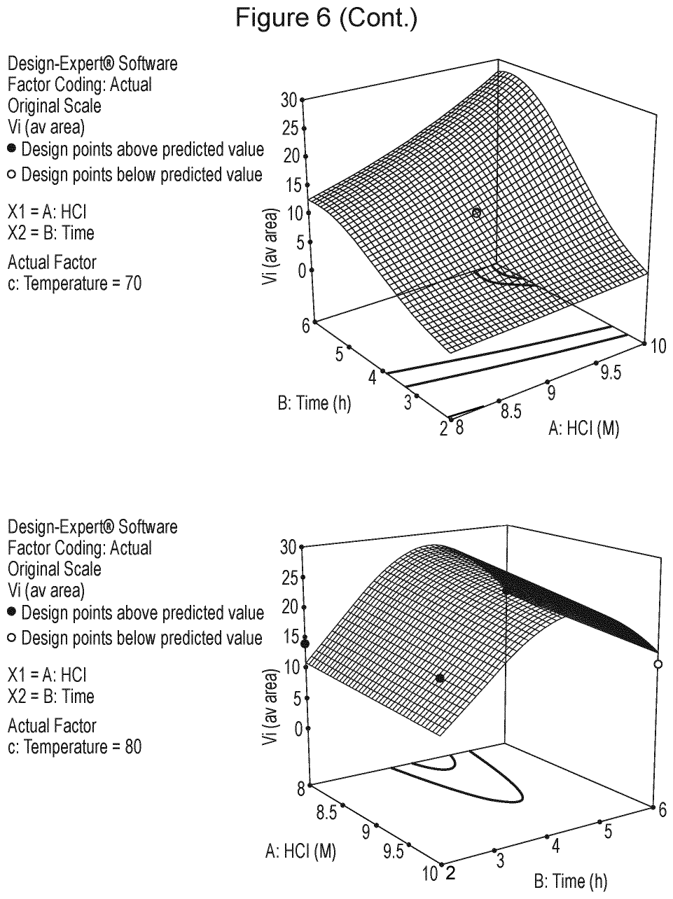

FIG. 6. Identification of optimal hydrolysis conditions for Vi quantification by acid hydrolysis followed by HPAEC-PAD: second DOE response surface and residuals normality plot.

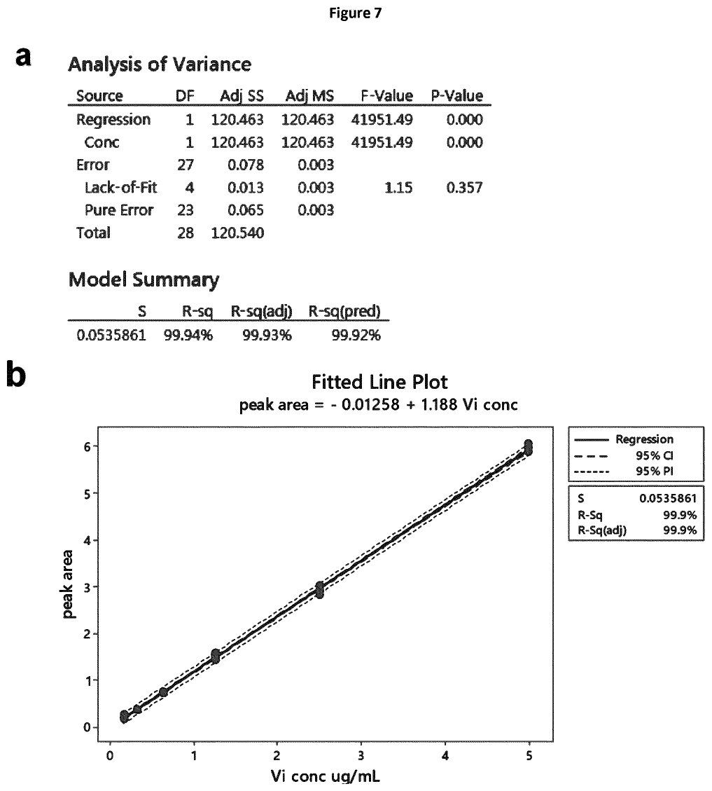

FIG. 7. Linearity determination for quantification of Vi by acid hydrolysis followed by HPAEC-PAD: a) ANOVA on 5 replicates run for the calibration curve; b) replicates of the calibration curve.

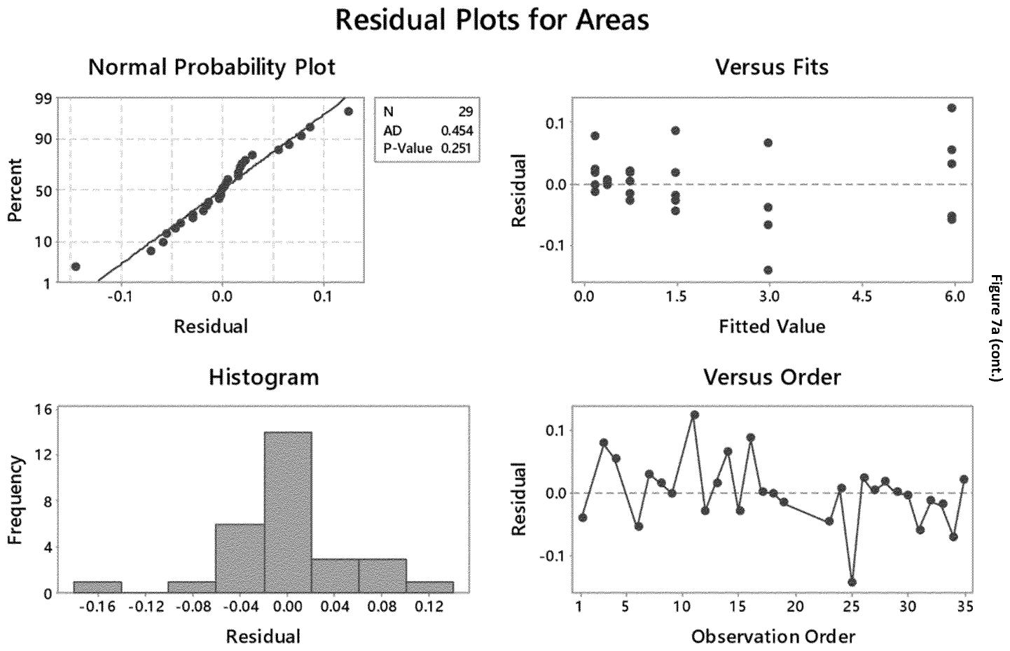

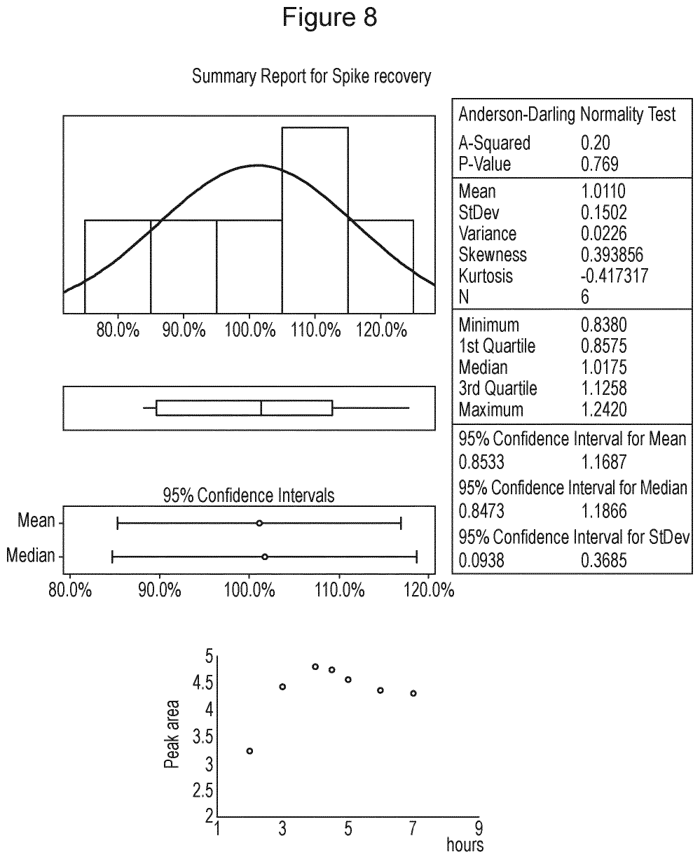

FIG. 8. Accuracy determination (spike recovery) for Vi quantification in conjugate samples.

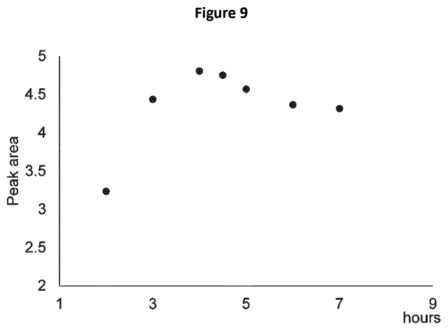

FIG. 9. Kinetic of hydrolysis for quantification of S. sonnei O-antigen.

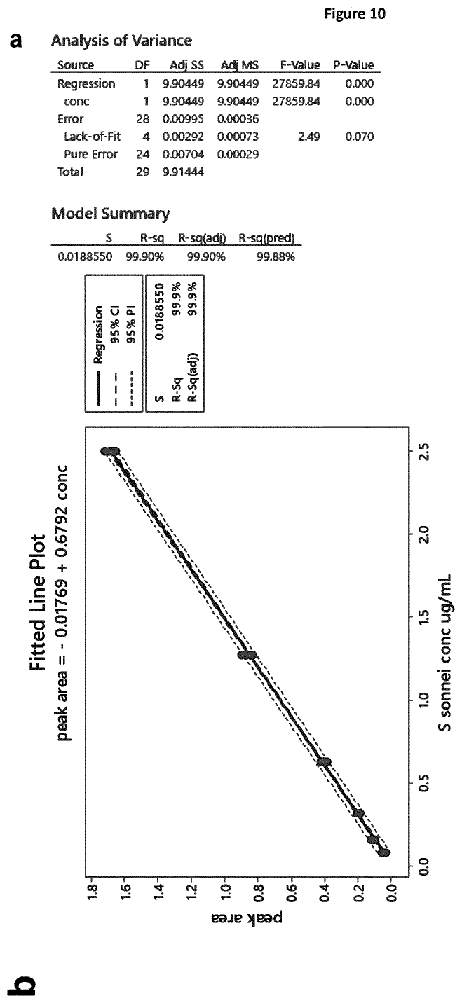

FIG. 10. Linearity determination for quantification of S. sonnei O-antigen by acid hydrolysis followed by HPAEC-PAD: a) ANOVA on 5 replicates of the calibration curve; b) replicates of the calibration curve.

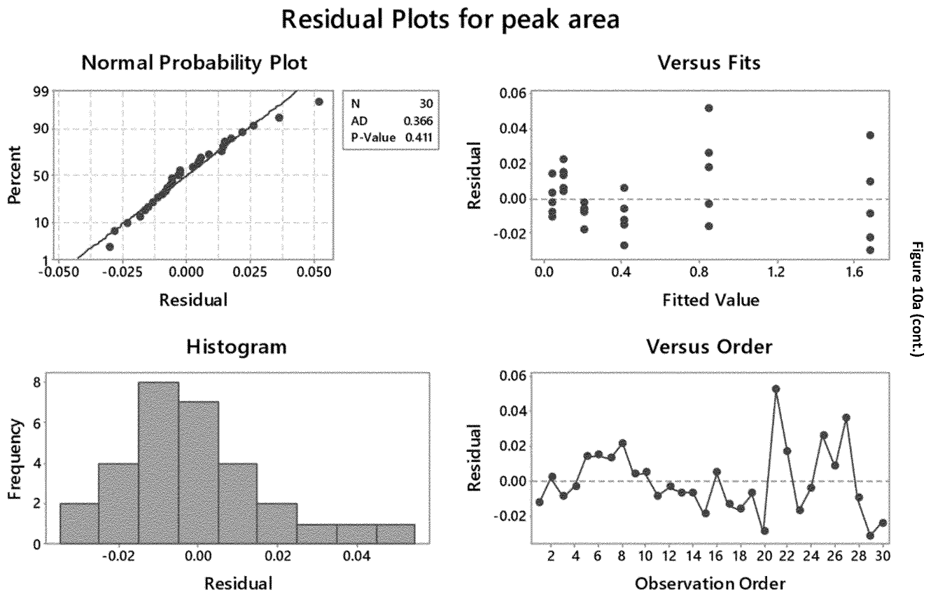

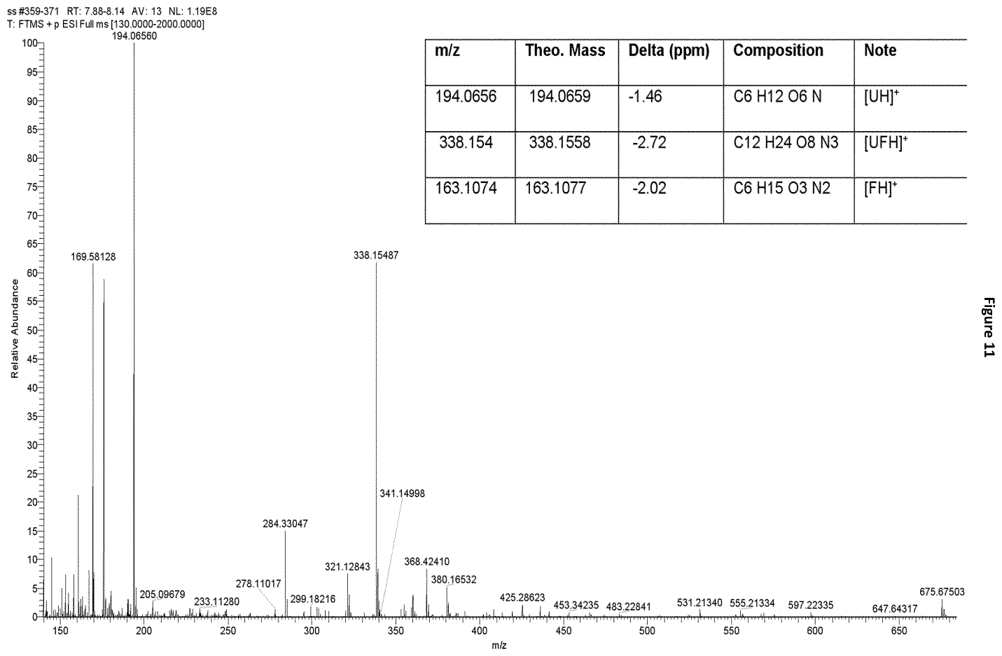

FIG. 11. MS analysis of the product coming from acid hydrolysis of S. sonnei O-antigen in the optimal conditions identified.

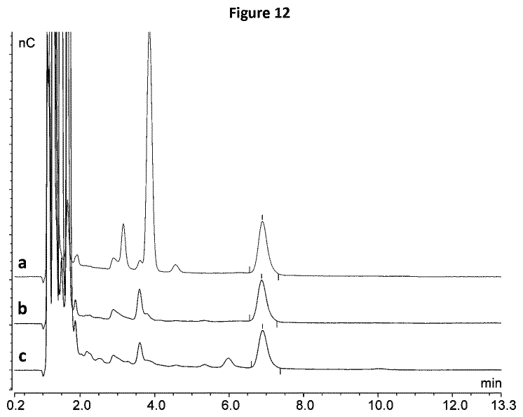

FIG. 12. HPAEC-PAD chromatograms after HCl/TFA hydrolysis of Staphylococcus aureus type 8 (a), type 5 (b) and Streptococcus pneumoniae serotype 12F (c) polysaccharides.

### EXAMPLES

1. Introduction

Typhoid fever is major cause of morbidity and mortality in developing countries. Vaccines based on the Vi capsular polysaccharide are licensed or in development against typhoid fever. Vi content is a critical quality attribute for vaccines release, to monitor their stability and to ensure appropriate immune response. Vi polysaccharide is an homopolymer of q-1,4-N-acetylgalactosaminouronic acid, O-acetylated at the C-3 position, resistant to commonly used acid hydrolysis for sugar chain depolymerization before monomers quantification. We previously developed a quantification method based on strong alkaline hydrolysis followed by HPAEC-PAD analysis, but with low sensitivity and using for quantification an unknown product coming from polysaccharide depolymerization.

Here we describe the development of a method for Vi polysaccharide quantification, based on acid hydrolysis with concomitant use of trifluoroacetic and hydrochloric acids. A DoE approach was used for the identification of optimal hydrolysis conditions. The method is 100-fold more sensitive than the previous one, and specific, resulting in the formation of a known product, confirmed to be the Vi monomer both de-O- and de-N-acetylated by mono- and bi-dimensional NMR spectroscopy and mass spectrometry. Accuracy and precision were determined, and chromatographic conditions were improved to result in reduced time of analysis.

This method will facilitate characterization of Vi based vaccines. Furthermore, a similar approach has the potentiality to be extended to other polysaccharides containing 2-amino uronic acids, as already verified here for Shigella sonnei O-antigen, Streptococcus pneumoniae serotype 12F and Staphylococcus aureus types 5 and 8 capsular polysaccharides.

2. Materials and methods

2.1. Materials

Sodium hydroxide (NaOH) 50% w/w (catalogue no. 7067) was purchased from Baker. Trifluoroacetic acid (TFA) (catalogue no. 299537) was purchased from Honeywell.

Maleic acid standard for quantitative NMR (qNMR) spectra (catalogue no. 92816), deuterium oxide (D₂O) (catalogue no. 151882), acetonitrile (catalogue no. 20060), hydrochloric acid (HCl) fuming 37% (catalogue no. 84436), glucuronic acid sodium salt monohydrate (catalogue no. G8645) and galacturonic acid monohydrate (catalogue no. 48280) were purchased from Sigma-Aldrich.

Pure water grade 1, >18 MΩ-cm at 25° C., was prepared by purifying deionized water.

Acroprep Advance 96 filter plate 0.2 μm Supor (catalogue no. 8119) was purchased from Pall. One mL 96 Deepwell plate (catalogue no. 260252), 96 well conical BTM PP plate (catalogue no. 249944), and pre-slit well cap for 96 well PP plate (catalogue no. 276011) were purchased from Thermo. Screw cap glass vials 2 mL, and W/Teflon rubber lined cup (catalogue no. 224741) were purchased from Wheaton. Combitip plus 5 mL (catalogue no. 0030069.250) were purchased from Eppendorf.

Vi purified polysaccharide, Shigella sonnei purified O-antigen, and Vi-CRM₁₉₇ conjugate were prepared as previously described^{11, 24}. Streptococcus pneumoniae serotype 12F and Staphylococcus aureus types 5 and 8 capsular polysaccharides were kindly provided by GSK.

2.2. Safety Considerations

All the hydrolysis steps were handled in a fume hood to avoid exposure to TFA and HCl.

2.3. Optimized Hydrolysis Conditions

TFA-HCl mixture was prepared by mixing TFA to HCl in a 2:13 v/v ratio in a glass bottle. Three hundred microliters of solution containing polysaccharide sample/standard in a 2 mL screw cap vial were added to 1 mL TFA-HCl mixture using an Eppendorf Xstream Electronic Pipettors; the lid was closed, and the content was mixed by vortexing.

The hydrolysis vials containing samples/standards were placed inside a SBH130D/3 Stuart Thermoblock equipped with three preheated SHT1 12 33 Stuart aluminum blocks, at 80° C. for 4.5 hours. The temperature was monitored with a glass thermometer inserted in the aluminum block.

After hydrolysis, the vials were removed from the block heater and cooled to room temperature. The content of the vials was then evaporated using nitrogen flush with a Techne sample concentrator FSC400D equipped with PTFE coated needles FSC4NCS.

After drying, the content of each vial was re-dissolved in 300 μL of water and accurately mixed by vortexing. The content of each vial was transferred into a 0.2 filtration 96-well plate placed over a 96 conical BTM plate and centrifuged (Beckmann Allegra X-15 with SX4750 swinging-bucket rotor and 393070 microplate carrier) at 524 rcf for 1 minute to collect filtered samples.

The plate containing filtered sample/standard solutions was covered with the pre-slit 96-well cap and put in the HPAEC-PAD autosampler compartment.

2.4. High Performance Anion Exchange Chromatography with Pulsed Amperometric Detection (HPAEC-PAD)

The chromatographic runs were performed on Thermo ICS-5000 (Chromeleon 7.2) or ICS-3000 (Chromeleon 6.8) using pulsed Amperometric mode with gold working electrode and Ag/AgCl reference electrode applying standard quad carbohydrate waveform.

The separation was performed on a Thermo CarboPac PA1 4×250 analytical column with Thermo CarboPac PA1 4×50 guard column. The column and detector compartments were held at 25° C., the sample compartment at 10° C.

A solution of glucuronic acid and galacturonic acid (5 μg/ml each) was injected three times before the analysis as a system suitability test, checking plate count and asymmetry value of the peaks. Chromatographic conditions used were: 25 μL injection, total run time of 15 minutes, with isocratic elution in 400 mM NaOH at a flow rate of 1.5 mL/min, with no washing step between sample/standard runs. At the end of the analysis, the column was stored in 200 mM NaOH after washing with 500 mM NaOH with a flow rate of 1 mL/min for 20 minutes.

For quantification, two calibration curves were run, one at the beginning and one at the end of the sample list; calibration curve points were accepted if the residual was lower than 10% (15% for the lowest calibration point) discarding a maximum of one point per analysis.

Each sample was analysed in triplicate and the results were averaged. Dixon Q test 99% (Q threshold value of 0.994) was used to have the possibility of removing one of the three hydrolysis replicates from the average.

2.5. Nuclear Magnetic Resonance (NMR) Spectroscopy

Spectra were recorded at 298K with a Bruker Avance III 400 spectrometer using standard pulse sequences. ¹H-NMR spectra were recorded at 400 MHz, chemical shift values are reported in ppm; solvent peak for D₂O was calibrated at 4.79 ppm. ¹³C-NMR spectra were recorded at 100 MHz.

The ¹H- ¹³C NMR spectra of the monomer were assigned using two-dimensional experiments: COSY and HSQC. 1 mg of Vi polysaccharide sample was hydrolyzed in the optimized hydrolysis condition, the hydrolysis mixture was dried under nitrogen flush and resuspended in 650 μL of D₂O.

For quantitative NMR (qNMR) spectra, a solution of Vi polysaccharide was transferred in two screw cap vials and dried, to have 1 mg of polysaccharide (one reference and one for hydrolysis) in each vial. The sample subjected to hydrolysis was resuspended in water and treated with a final mixture of HCl 8 M 10% TFA for 4.5 h at 80° C., then dried.

The dried polysaccharide used as reference and the dried hydrolysed polysaccharide were resuspended in D₂O (500 μL) and 150 μL of maleic acid standard solution (350 μg/mL) was added. The polysaccharide in the reference vial was de-O-acetylated adding 35 μL of NaOH 4M in D₂O and warming at 37° C. for 2 h. Spectra were acquired using a total recycle time to ensure a full recovery of each signal (5×Longitudinal Relaxation Time T1).

The hydrolysed sample was quantified using the ratio between the sum of the H-3α and H-3β signals and the maleic acid internal standard. The de-O-acetylated polysaccharide was quantified using the ratio between the N-acetyl signal and the maleic acid internal standard. The hydrolysis yield was estimated by calculation, as a ratio between the two quantifications.

2.6. Mass Spectrometry (MS)

High resolution mass spectra were recorded on Q-Exactive plus (Thermo) by direct infusion of the sample at 10 μL/min. One milligram of polysaccharide was hydrolyzed in the optimized conditions and dried, resuspended at 200 μg/mL final concentration in 80% acetonitrile/20% water. The following parameters were used: scan range 80-2000 m/z; resolution 70000, positive ion mode, sheath gas flow rate 5, auxiliary gas flow rate 1, sweep gas flow rate 0, spray voltage 3.8 KV, capillary temperature 100° C., S-lens RF level 60 and aux gas heater 40° C.

2.7. Design of Experiment

Experimental planning and data elaboration were performed with Design Expert 10, Stat-Ease Inc.

2.8. Statistical Analysis

Statistical analyses were performed with Minitab 18, Minitab Inc.

3. Results

3.1. DoE Approach for Identification of Optimal Vi Hydrolysis Conditions After a few preliminary and promising test results were obtained, verifying the possibility to hydrolyse Vi polysaccharide with concomitant use of TFA and HCl, traditionally reported for analysis of aminoacidic composition of proteins²⁵, a first DoE experiment was performed. A split-plot with temperature as hard to change factor, response surface method, spherical design (alpha=2) was used (Table 2 reports a detailed list of experiments performed).

HCl concentration, TFA concentration, time of hydrolysis and temperature were the factors evaluated in the range 5-8 M, 10-20% v/v, 2-5 h, 80-110° C. respectively. Each hydrolysis test was performed on a total volume of 450 μL at 7 μg/mL Vi, with the acid hydrolysis mixture composition, time and temperature as detailed in Table 2. After the hydrolysis, samples were dried and stored at 4° C. until the analysis. After having performed all the hydrolyses, all the samples were resuspended in 300 μL of water and analysed by HPAEC-PAD; the injection order followed the same randomization scheme used for the hydrolysis (Table 2).

The optimisation was performed with the aim of maximizing the hydrolysis yield with respect to the analyte chromatographic peak area.

To elaborate the data, a response surface with a quadratic model was chosen and the data were log transformed before analysis. Non-significant terms (p-value>0.05) were removed from the model using a backward elimination process (statistical analysis and results are reported in Table 3 and FIG. 5). The outcome of the experiment was considered as basis for further experiments, as the adjusted R² was 0.94. Conditions that led to the highest peak area in the design space tested were HCl 8 M, 5 h, 80° C. (FIG. 5), while the variation of the TFA concentration was not relevant in the 10-20% range tested.

Based on these results, an experiment was performed comparing hydrolysis for 5 h at 80° C., with 8 M HCl with and without 10% TFA. In the presence of TFA, the area of the resulting analyte peak was about two times higher than the corresponding peak obtained without TFA. This confirms that the variation of TFA concentration has no effect in the range of 10-20%, but presence of TFA is needed to assure a more efficient hydrolysis.

To reduce the number of tests in the subsequent optimization, the TFA percentage in the hydrolysis mixture was held at 10% (v/v).

A second DoE was performed, again with a split-plot with temperature as hard-to-change factor, response surface method, spherical design (alpha=1.73) (Table 4) changing HCl concentration from 8 to 10 M, the hydrolysis time in the range 2-6 h and the temperature in the range 60-80° C.

Again, a response surface with a quadratic model was chosen and the data were log transformed before analysis. With a backward elimination process, the non-significant terms (p-value>0.05) were removed from the model (Table 5 and FIG. 6). The residuals were normally distributed (Ryan-Joiner test, P>0.1) and the model resulted with an adjusted-R² of 0.97.

Based on the results 8 M HCl, 10% TFA, 4.5 h, 80° C. were selected as optimized hydrolysis conditions (FIG. 2).

3.2. The Vi Hydrolysis Product has the Expected Structure of 2-Amino-Galacturonic Acid Monosaccharide

One of the main drawbacks of our previous method for quantification of Vi polysaccharide by alkaline hydrolysis followed by HPAEC-PAD²² was the formation of an unknown product of degradation through hydrolysis. We aimed to characterize the product coming from the new hydrolysis.

Vi polysaccharide was hydrolyzed in the optimized conditions identified through the DoE experiment (8 M HCl, TFA 10%, 4.5 h, 80° C.). The resulting product was characterized by ¹H NMR, ¹³C-NMR, COSY (FIG. 3a) and HSQC (FIG. 3b), allowing identification of the signals corresponding to 2-amino-galacturonic acid monosaccharide in equilibrium between a and 3 conformations (FIG. 3a). Below assignment of ¹H- and ³C-NMR signals is reported.

¹H NMR (400 MHz, D₂O) δ 5.51 (d, J=3.6, 1H, H-1α), 5.04 (m, 1H, H-5β), 4.88 (d, J=8.5, 1H, H-1β), 4.70 (d, J=0.8 Hz, 1H, H-5α), 4.34 (m, 1H, H-4α), 4.17 (m, 1H, H-4β), 4.15 (dd, J=3.2, 10.9 Hz, 1H, H-3α), 3.94 (dd, J=3.3, 10.9 Hz, 1H, H-3β), 3.48 (dd, J=3.6, 10.9 Hz, H-2α), 3.19 (dd, J=8.50, 10.9 Hz, H-2β).

¹³C NMR (100 MHz, D₂O) δ 100.3 (CO), 92.8 (C-1β), 89.2 (C-1α), 71.4 (C-5β), 70.4 (C-5α), 69.1 (C-4α), 68.9 (C-3β), 65.9 (C-3α), 50.7 (C-2α), 53.8 (C-2β).

Signals at 50.7 and 53.8 ppm in the HSQC spectrum (FIG. 3b) are characteristic of C—N linkage, confirming no loss of the amino group after hydrolysis.

Formation of the expected amino-uronic de-O- and de-N-acetylated monomer was also confirmed by MS analysis (FIG. 3c). The ion at 194.06609 u corresponded to C₆H₁₂NO₆ [M+H]⁺ (vs calculated 194.06591), while the ion at 216.04797 u to the sodium adduct C₆H₁₁NO₆Na [M+Na]⁺ (vs calculated 216.04786). The ion having 176.05548 u corresponded to its de-hydrated form. The peak at 284.33132 u was attributed to the surfactant cetyltrimethylammonium (CTA), residual from the polysaccharide purification¹¹.

Using orthogonal techniques (NMR and MS) we demonstrated that the hydrolysis conditions identified lead to the completely de-acetylated Vi monomer with a recovery of 99.3%, as calculated by qNMR.

3.3. Linearity Determination

To assess the linearity of the novel method, five different replicates of the calibration curve were run at Vi concentrations of 0.15, 0.31, 0.62, 1.25, 2.5, 5, 10 μg/mL. Sample preparation order and chromatographic run order were randomised.

A regression analysis on the data generated showed a significant linear model and a non-significant lack of fit. However, the residuals did not have a normal distribution and could not be normalised using Box-Cox transformation of the data.

The regression analysis was then repeated by reducing the range of the calibration curve (highest calibration curve point from 10 to 5 μg/mL): the regression model was significant, the lack of fit not significant and the residuals resulted normally distributed without the need of data transformation (FIG. 7).

3.4. Repeatability and Intermediate Precision Determination

Precision of the method was determined for analysis of both unconjugated and conjugated Vi polysaccharide samples²⁶.

To assess precision for the analysis of Vi polysaccharide sample (2 μg/mL), a total of six analysis sessions were performed in six different days. Two operators ran 3 sessions each. In each session, samples preparation order and chromatographic run order were randomized.

An analogous experimental design was used to assess precision for the analysis of Vi-CRM conjugate sample (2.5 μg/mL Vi).

ANOVA variance component analysis (general linear model with random factors and analysis sessions nested in the operator) was used to estimate the intermediate precision (defined as the variability among different sessions, different analysts), the repeatability (defined as the variability under the same operating conditions over a short interval of time) and the operator and analysis session contributions to the variability (Table 6).

Results obtained, reported as % coefficient of variation (CV), are presented in Table 1 for both sample types.

3.5. Accuracy Determination

The accuracy was not estimated for Vi sample as the same substance is used to build the calibration curve. The accuracy for Vi-CRM sample was estimated using spike recovery technique.

1 μg/mL Vi polysaccharide was spiked to Vi-CRM conjugate sample (tested at a concentration of 2.5 μg/mL of Vi).

To assess spike recovery, a total of six analysis sessions was performed in six different days. Two operators ran 3 sessions each. In each session, samples preparation order and chromatographic run order were randomized. For each analysis session, the recovered amount of spiked polysaccharide on the theoretical spike was calculated. The average of results was 101% recovery, with a confidence interval (95%) of 85-117% (FIG. 8).

3.6. Same Method Extended to Quantification of S. sonnei O-Antigen by HPAEC-PAD

Conditions of hydrolysis optimized for Vi were applied to S. sonnei O-antigen. Also S. sonnei O-antigen contains a N-acetyl-amino uronic acid in its repeating unit (FIG. 1b), making the polymer resistant to commonly used acid hydrolysis for sugar chain depolymerization before monomers quantification by HPAEC-PAD²⁴.

For quantification of such sugar, we had previously applied same alkaline hydrolysis conditions and HPAEC-PAD analysis used for Vi quantification²⁴. Chromatograms revealed formation of the same unknown species derived from Vi hydrolysis (FIG. 4 a, b). After hydrolysis with HCl/TFA, two different products from hydrolysis of Vi and S. sonnei O-antigen were instead identified by HPAEC-PAD, as expected (FIG. 4 c, d). Analyzing the chromatograms in FIG. 4, we observed that both for Vi and S. sonnei O-antigen the peaks coming from acid and alkaline hydrolysis had respectively peak width of 0.42 min compared to 0.32 min with similar asymmetry, close to 1.

A kinetic of hydrolysis performed with 8 M HCl and 10% TFA at 80° C. was performed for S. sonnei O-antigen, confirming maximum area of the detected peak close to 4.5 h (FIG. 9). Also, linearity of the method in the range 0.08-2.5 μg/mL was verified (FIG. 10).

Analysis by MS of the product of hydrolysis (FIG. 11) was consistent with the completely de-acetylated amino-uronic acid (U) at 194.0656 u corresponding to C₆H₁₂NO₆ [U+H]⁺ (vs calculated 194.0659), the peak of de-acetylated di-fucosamine (F) at 163.1074 u corresponding to C₆H₁₅N₂O₃ [F+H]⁺ (vs calculated 163.1077). Also, presence of the peak corresponding to the disaccharide repeating unit (UF) C₁₂H₂₄N₃O₈ [UF+H]⁺ was found at 338.154 u (vs calculated 338.1558).

3.7. TFA/HCl Hydrolysis Extended to Other Polysaccharides Containing 2-Amino Uronic Acids

In order to collect further evidence that the method developed could be extended to other polysaccharides containing 2-amino uronic acids, optimized conditions for Vi were tried with Streptococcus pneumoniae serotype 12F and Staphylococcus aureus types 5 and 8 capsular polysaccharides^{27, 28}, performing a kinetic of hydrolysis in the range 1-7 h.

All the three polysaccharides selected contain N-acetyl-amino mannuronic acid in their structure. In fact, after hydrolysis we identified the formation of a peak eluting at the same retention time for all of them (FIG. 12), with maximum area after 3 h of hydrolysis. Analysis by MS of the products of hydrolysis confirmed in all cases the presence of de-N-acetylated amino-uronic acid. MS analysis also revealed presence of fucosamine, common to all the three structures.

4. Discussion

There are already marketed vaccines against S. Typhi, with many others under development and many of them are based on the Vi capsular polysaccharide^{7,8}.

Polysaccharide content is one of the critical quality attributes of Vi based vaccines. WHO has suggested colorimetric methods^{16, 23} or the HPAEC-PAD procedure we previously developed²² for Vi quantification¹⁴. However, such methods suffer for low specificity and low sensitivity, and are often difficult to apply to Vi quantification in final drug products. Hestrin, for example, is an indirect method for O-acetyl quantification, and acridine orange can detect whatever polysaccharide characterized by the presence of carboxylic groups at a certain spatial distance.

One of the major obstacles to the development of a sensitive and specific method for Vi quantification is its resistance to common procedures of acid hydrolysis, usually applied to depolymerize polysaccharides before their monomer sugars quantification¹⁷⁻²¹. Here we have identified a new hydrolysis procedure, based on contemporary use of TFA and HCl, that has allowed to reduce the Vi polysaccharide to its de-O- and de-N-acetylated monomer. Formation of such species with total recovery, in optimized conditions of hydrolysis identified, has been confirmed by MS and NMR experiments. We can hypothesize that, as reported for proteins²⁵, the presence of TFA makes more accessible to hydrolysis hydrophobic regions of the polysaccharide chain, allowing the hydrolysis in milder conditions that avoid sugar degradation.

The high yield of hydrolysis obtained together with formation of a well-defined species, made the new method not only specific but also ˜100-fold more sensitive than the alkaline based HPAEC-PAD procedure we previously developed. LOQ of 0.15 μg/mL vs 16 μg/mL has been achieved. The procedure reported here for Vi depolymerization could be used to generate a monomer that could be easily standardized and used to build the calibration curve.

A DOE approach has been applied to identify optimal hydrolysis conditions. Use of such methodology allows one to reduce number of tests and identify optimal combinations of reaction conditions. Also, chromatographic conditions were modified to reduce running time from 31 minutes for the original HPAEC-PAD analysis to less than 15 minutes.

The method has proven to be precise and accurate for quantification of both unconjugated and conjugated Vi. The variability found (close to 5%) can be mainly attributed to repeatability, with no significant contribution from the operator.

Same procedure optimized for Vi was successfully extended to S. sonnei O-antigen. Shigella infections are one of the top causes of Moderate to Severe Diarrheal throughout the world. The recently published Global Burden of Disease Study 2016 estimates approximately 112 million cases with 238,000 total deaths per year, 30% in children younger than 5 years, 98.5% in low-middle income countries²⁹. No vaccines are currently licensed against Shigella and many O-antigen based vaccines are under development³⁰. Analysis by MS confirmed also in this case formation of the expected monomers. Presence of the repeating unit could be due to high sensitivity of the method, as such peak was not detected by HPAEC-PAD chromatography.

This new method will facilitate characterization of Vi based vaccines and will find application for vaccine release and vaccine stability to be followed over time. Furthermore, a similar approach could be extended to other polysaccharides containing 2-amino uronic acids, as already shown here for Shigella sonnei O-antigen, for which current quantification methods show limitations similar to those of the previous method used for quantification of Vi²⁴, Streptococcus pneumoniae serotype 12F and Staphylococcus aureus types 5 and 8 capsular polysaccharides.

5. Conclusions

Here a novel method for quantification of Vi based vaccines against S. Typhi is described. This method relies on acid hydrolysis of the polysaccharide with concomitant use of TFA and HCl, followed by HPAEC-PAD analysis. The conditions identified result in complete hydrolysis of the polysaccharide in its de-O- and de-N-acetylated monomer. This allowed to put in place a more specific and sensitive quantification method respect to those used so far. We have already shown that the method can be extended to quantification of other polysaccharides containing amino uronic acids.

Tables

TABLE 1
Vi quantification by acid hydrolysis followed by HPAEC-PAD: intermediate
precisions and repeatability determination for analysis of Vi and Vi-CRM.

| | Intermediate | | | |
|---|---|---|---|---|
| Sample | precision | Repeatability | Operator | Analysis Session |
| Vi | 5.6% | 5.3% | 0.0% | 1.9% |
| | | | (not significant p = 0.387) | (not significant p = 0.300) |
| Vi-CRM | 5.1% | 3.0% | 3.1% | 2.8% |
| conjugate | | | (not significant p = 0.127) | (significant p = 0.042) |

TABLE 2
Identification of optimal hydrolysis conditions
for Vi quantification by acid hydrolysis followed
by HPAEC-PAD: first DOE set of experiments.

| | Groups | Runs per Group |
|---|---|---|
| Center Point | 3 | 3 |
| Factorial | 2 | 8 |
| Hard to change Axial | 2 | 2 |
| Easy to change Axial | 1 | 6 |
| Total | 8 | 35 |

| | | | Factor 1 | Factor 2 | Factor 3 | Factor 4 |
|---|---|---|---|---|---|---|
| | | | A: HCl | B: TFA | C: Time | d: Temperature |
| Std | Group | Run | M | % | hours | ° C. |
| 21 | 1 | 1 | 6.5 | 15 | 3.5 | 65 |
| 20 | 1 | 2 | 6.5 | 15 | 3.5 | 65 |
| 17 | 2 | 3 | 6.5 | 15 | 3.5 | 95 |
| 18 | 2 | 4 | 6.5 | 15 | 3.5 | 95 |
| 19 | 2 | 5 | 6.5 | 15 | 3.5 | 95 |
| 28 | 3 | 6 | 6.5 | 15 | 0.5 | 95 |
| 24 | 3 | 7 | 3.5 | 15 | 3.5 | 95 |
| 29 | 3 | 8 | 6.5 | 15 | 6.5 | 95 |
| 25 | 3 | 9 | 9.5 | 15 | 3.5 | 95 |
| 26 | 3 | 10 | 6.5 | 5 | 3.5 | 95 |
| 27 | 3 | 11 | 6.5 | 25 | 3.5 | 95 |
| 22 | 4 | 12 | 6.5 | 15 | 3.5 | 125 |
| 23 | 4 | 13 | 6.5 | 15 | 3.5 | 125 |
| 8 | 5 | 14 | 8 | 20 | 5 | 80 |
| 5 | 5 | 15 | 5 | 10 | 5 | 80 |
| 4 | 5 | 16 | 8 | 20 | 2 | 80 |
| 1 | 5 | 17 | 5 | 10 | 2 | 80 |
| 6 | 5 | 18 | 8 | 10 | 5 | 80 |
| 7 | 5 | 19 | 5 | 20 | 5 | 80 |
| 2 | 5 | 20 | 8 | 10 | 2 | 80 |
| 3 | 5 | 21 | 5 | 20 | 2 | 80 |
| 16 | 6 | 22 | 8 | 20 | 5 | 110 |
| 11 | 6 | 23 | 5 | 20 | 2 | 110 |
| 15 | 6 | 24 | 5 | 20 | 5 | 110 |
| 14 | 6 | 25 | 8 | 10 | 5 | 110 |
| 10 | 6 | 26 | 8 | 10 | 2 | 110 |
| 9 | 6 | 27 | 5 | 10 | 2 | 110 |
| 13 | 6 | 28 | 5 | 10 | 5 | 110 |
| 12 | 6 | 29 | 8 | 20 | 2 | 110 |
| 33 | 7 | 30 | 6.5 | 15 | 3.5 | 95 |
| 34 | 7 | 31 | 6.5 | 15 | 3.5 | 95 |
| 35 | 7 | 32 | 6.5 | 15 | 3.5 | 95 |
| 31 | 8 | 33 | 6.5 | 15 | 3.5 | 95 |
| 30 | 8 | 34 | 6.5 | 15 | 3.5 | 95 |
| 32 | 8 | 35 | 6.5 | 15 | 3.5 | 95 |

TABLE 3
Identification of optimal hydrolysis conditions for Vi
quantification by acid hydrolysis followed by HPAEC-PAD:
statistical analysis of the model for the first DOE.
REML (REstricted Maximum Likelihood) analysis
for selected model Kenward-Roger p-values
Fixed Effects [Type III]

| | Term | Error | | p-value | |
|---|---|---|---|---|---|
| Source | df | df | F | Prob > F | |
| Whole-plot | 2 | 5.60 | 16.19 | 0.0047 | significant |
| d-Temperatura | 1 | 5.55 | 14.86 | 0.0098 | |
| d\hat{ }2 | 1 | 5.64 | 17.52 | 0.0066 | |
| Subplot | 5 | 22.37 | 15.00 | <0.0001 | significant |
| A-HCl | 1 | 22.15 | 2.61 | 0.1202 | |
| C-Tempo | 1 | 22.15 | 3.04 | 0.0949 | |
| Ad | 1 | 22.15 | 45.11 | <0.0001 | |
| Cd | 1 | 22.15 | 12.38 | 0.0019 | |
| A\hat{ }2 | 1 | 23.29 | 11.86 | 0.0022 | |

Variance Components

| Source | Variance | StdErr | 95% CI Low | 95% CI High |
|---|---|---|---|---|
| Group | 0.20 | 0.14 | −0.064 | 0.47 |
| Residual | 0.059 | 0.018 | 0.035 | 0.12 |
| Total | 0.26 | | | |

| | | | |
|---|---|---|---|
| −2 Log Likelihood | 39.63 | BIC | 75.18 |
| R-Squared | 0.95 | AIC | 59.63 |
| Adj R-Squared | 0.94 | AICc | 68.79 |

| | Coefficient | Standard | |
|---|---|---|---|
| Source | Estimate | Error | VIF |
| Intercept | 0.59 | 0.21 | |
| Whole-plot Terms: | | | |
| d-Temperatura | −0.58 | 0.15 | 1.00 |
| d\hat{ }2 | −0.43 | 0.10 | 1.00 |
| Subplot Terms: | | | |
| A-HCl | −0.080 | 0.049 | 1.00 |
| C-Tempo | −0.086 | 0.049 | 1.00 |
| Ad | −0.41 | 0.061 | 1.00 |
| Cd | −0.21 | 0.061 | 1.00 |
| A\hat{ }2 | −0.18 | 0.052 | 1.00 |

TABLE 4
Identification of optimal hydrolysis conditions
for Vi quantification by acid hydrolysis followed
by HPAEC-PAD: second DOE set of experiments.

| | Groups | Runs per Group |
|---|---|---|
| Center Point | 3 | 3 |
| Factorial | 2 | 4 |
| Hard to change Axial | 2 | 2 |
| Easy to change Axial | 1 | 4 |
| Total | 8 | 25 |

| | | | Factor 1 | Factor 2 | Factor 3 |
|---|---|---|---|---|---|
| | | | A: HCl | B: Time | c: Temperature |
| Std | Group | Run | M | h | ° C. |
| 14 | 1 | 1 | 9 | 4 | 52.7 |
| 12 | 1 | 2 | 9 | 4 | 52.7 |
| 13 | 1 | 3 | 9 | 4 | 52.7 |
| 25 | 2 | 4 | 9 | 4 | 70 |
| 27 | 2 | 5 | 9 | 4 | 70 |
| 26 | 2 | 6 | 9 | 4 | 70 |
| 18 | 3 | 7 | 7.27 | 4 | 70 |
| 20 | 3 | 8 | 9 | 0.536 | 70 |
| 21 | 3 | 9 | 9 | 7.46 | 70 |
| 19 | 3 | 10 | 10.7 | 4 | 70 |
| 3 | 4 | 11 | 8 | 6 | 60 |
| 4 | 4 | 12 | 10 | 6 | 60 |
| 1 | 4 | 13 | 8 | 2 | 60 |
| 2 | 4 | 14 | 10 | 2 | 60 |
| 9 | 5 | 15 | 9 | 4 | 70 |
| 10 | 5 | 16 | 9 | 4 | 70 |
| 11 | 5 | 17 | 9 | 4 | 70 |
| 16 | 6 | 18 | 9 | 4 | 87.3 |
| 15 | 6 | 19 | 9 | 4 | 87.3 |
| 17 | 6 | 20 | 9 | 4 | 87.3 |
| 8 | 7 | 21 | 10 | 6 | 80 |
| 7 | 7 | 22 | 8 | 6 | 80 |
| 6 | 7 | 23 | 10 | 2 | 80 |
| 5 | 7 | 24 | 8 | 2 | 80 |
| 22 | 8 | 25 | 9 | 4 | 70 |
| 24 | 8 | 26 | 9 | 4 | 70 |
| 23 | 8 | 27 | 9 | 4 | 70 |

TABLE 5
Identification of optimal hydrolysis conditions for Vi
quantification by acid hydrolysis followed by HPAEC-PAD:
statistical analysis of the model for the second DOE.
REML (REstricted Maximum Likelihood) analysis
for selected model Kenward-Roger p-values
Fixed Effects [Type III]

| | Term | Error | | p-value | |
|---|---|---|---|---|---|
| Source | df | df | F | Prob > F | |
| Whole-plot | 2 | 5.38 | 249.36 | <0.0001 | significant |
| c-Temperature | 1 | 5.11 | 354.95 | <0.0001 | |
| c\hat{ }2 | 1 | 5.68 | 143.85 | <0.0001 | |
| Subplot | 5 | 15.72 | 61.37 | <0.0001 | significant |
| A-HCl | 1 | 14.56 | 20.95 | 0.0004 | |
| B-Time | 1 | 14.56 | 166.60 | <0.0001 | |
| Ac | 1 | 14.56 | 17.72 | 0.0008 | |
| Bc | 1 | 14.56 | 57.05 | <0.0001 | |
| B\hat{ }2 | 1 | 17.87 | 46.32 | <0.0001 | |

Variance Components

| Source | Variance | StdErr | 95% CI Low | 95% CI High |
|---|---|---|---|---|
| Group | 0.025 | 0.037 | −0.047 | 0.097 |
| Residual | 0.10 | 0.038 | 0.056 | 0.25 |
| Total | 0.13 | | | |

| | | | |
|---|---|---|---|
| −2 Log Likelihood | 36.00 | BIC | 68.96 |
| R-Squared | 0.98 | AIC | 56.00 |
| Adj R-Squared | 0.97 | AICc | 69.75 |

| | Coefficient | Standard | |
|---|---|---|---|
| Source | Estimate | Error | VIF |
| Intercept | 2.42 | 0.12 | |
| Whole-plot Terms: | | | |
| c-Temperature | 1.59 | 0.084 | 1.00 |
| c\hat{ }2 | −0.85 | 0.071 | 1.03 |
| Subplot Terms; | | | |
| A-HCl | 0.39 | 0.086 | 1.00 |
| B-Time | 1.11 | 0.086 | 1.00 |
| Ac | −0.48 | 0.11 | 1.00 |
| Bc | −0.86 | 0.11 | 1.00 |
| B\hat{ }2 | −0.66 | 0.097 | 1.03 |

TABLE 6
Repeatability and intermediate precision determination
for quantification of Vi by acid hydrolysis followed by
HPAEC-PAD in unconjugated and conjugate samples.
ANOVA results for Vi sample
General Linear Model: Vi ug/mL versus Operator; Session
Factor Information

| Factor | Type | Levels | Values |
|---|---|---|---|
| Operator | Random | 2 | 1; 2 |
| Session(Operator) | Random | 6 | S1(1); S2(1); S3(1); S1(2); S2(2); S3(2) |

Analysis of Variance

| Source | DF | Adj SS | Adj MS | F-Value | P-Value |
|---|---|---|---|---|---|
| Operator | 1 | 0.01444 | 0.01444 | 0.94 | 0.387 |
| Session(Operator) | 4 | 0.06130 | 0.01533 | 1.37 | 0.300 |
| Error | 12 | 0.13378 | 0.01115 | | |
| Total | 17 | 0.20952 | | | |

Variance Components, using Adjusted SS

| Source | Variance | % of Total | StDev | % of Total |
|---|---|---|---|---|
| Operator | −9.7922e−005* | 0.00% | 0.000000 | 0.00% |
| Session(Operator) | 0.0013925 | 11.10% | 0.037317 | 33.32% |
| Error | 0.0111480 | 88.90% | 0.105584 | 94.28% |
| Total | 0.0125406 | | 0.111985 | |

*Value is negative, and is estimated by zero.

ANOVA results for fVi-CRM sample
General Linear Model: Vi-CRM ug/mL versus Session; Operator
Factor Information

| Factor | Type | Levels | Values |
|---|---|---|---|
| Session(Operator) | Random | 6 | S1(1); S2(1); S3(1); S1(2); S2(2); S3(2) |
| Operator | Random | 2 | 1; 2 |

Analysis of Variance

| Source | DF | Adj SS | Adj MS | F-Value | P-Value |
|---|---|---|---|---|---|
| Operator | 1 | 0.07666 | 0.076662 | 3.69 | 0.127 |
| Session(Operator) | 4 | 0.08905 | 0.020763 | 3.47 | 0.042 |
| Error | 12 | 0.07170 | 0.005975 | | |
| Total | 17 | 0.23142 | | | |

Variance Components, using Adjusted SS

| Source | Variance | % of Total | StDev | % of Total |
|---|---|---|---|---|
| Operator | 0.0062110 | 36.29% | 0.078810 | 60.24% |
| Session(Operator) | 0.0049299 | 28.80% | 0.070209 | 53.67% |
| Error | 0.0059752 | 34.91% | 0.077299 | 59.09% |
| Total | 0.0171155 | | 0.130826 | |

### REFERENCES

1. John, J.; Van Aart, C. J.; Grassly, N. C., The Burden of Typhoid and Paratyphoid in India: Systematic Review and Meta-analysis. PLoS neglected tropical diseases 2016, 10 (4), e0004616.
2. Maskey, A. P.; Day, J. N.; Phung, Q. T.; Thwaites, G. E.; Campbell, J. I.; Zimmerman, M.; Farrar, J. J.; Basnyat, B., Salmonella enterica serovar Paratyphi A and S. enterica serovar Typhi cause indistinguishable clinical syndromes in Kathmandu, Nepal. Clinical infectious diseases: an official publication of the Infectious Diseases Society of America 2006, 42 (9), 1247-53.
3. Wierzba, T. F.; Sanders, J. W., The global burden of enteric fevers in the age of typhoid-conjugate vaccines. The Lancet. Infectious diseases 2019, 19 (4), 340-341.
4. Dyson, Z. A.; Klemm, E. J.; Palmer, S.; Dougan, G., Antibiotic Resistance and Typhoid. Clinical infectious diseases: an official publication of the Infectious Diseases Society of America 2019, 68 (Supplement_2), S165-s170.
5. Klemm, E. J.; Shakoor, S.; Page, A. J.; Qamar, F. N.; Judge, K.; Saeed, D. K.; Wong, V. K.; Dallman, T. J.; Nair, S.; Baker, S.; Shaheen, G.; Qureshi, S.; Yousafzai, M. T.; Saleem, M. K.; Hasan, Z.; Dougan, G.; Hasan, R., Emergence of an Extensively Drug-Resistant Salmonella enterica Serovar Typhi Clone Harboring a Promiscuous Plasmid Encoding Resistance to Fluoroquinolones and Third-Generation Cephalosporins. MBio 2018, 9 (1).
6. Germanier, R.; Fuer, E., Isolation and characterization of Gal E mutant Ty 21α of Salmonella typhi: a candidate strain for a live, oral typhoid vaccine. J Infect Dis 1975, 131 (5), 553-8.
7. MacLennan, C. A.; Martin, L. B.; Micoli, F., Vaccines against invasive Salmonella disease: current status and future directions. Hum Vaccin Immunother 2014, 10 (6), 1478-93.
8. World Health, O., Typhoid vaccines: WHO position paper, March 2018—Recommendations. Vaccine 2019, 37 (2), 214-216.
9. Jin, C.; Gibani, M. M.; Moore, M.; Juel, H. B.; Jones, E.; Meiring, J.; Harris, V.; Gardner, J.; Nebykova, A.; Kerridge, S. A.; Hill, J.; Thomaides-Brears, H.; Blohmke, C. J.; Yu, L. M.; Angus, B.; Pollard, A. J., Efficacy and immunogenicity of a Vi-tetanus toxoid conjugate vaccine in the prevention of typhoid fever using a controlled human infection model of Salmonella Typhi: a randomised controlled, phase 2b trial. Lancet 2017, 390 (10111), 2472-2480.
10. Mohan, V. K.; Varanasi, V.; Singh, A.; Pasetti, M. F.; Levine, M. M.; Venkatesan, R.; Ella, K. M., Safety and immunogenicity of a Vi polysaccharide-tetanus toxoid conjugate vaccine (Typbar-TCV) in healthy infants, children, and adults in typhoid endemic areas: a multicenter, 2-cohort, open-label, double-blind, randomized controlled phase 3 study. Clinical infectious diseases: an official publication of the Infectious Diseases Society of America 2015, 61 (3), 393-402.
11. Micoli, F.; Rondini, S.; Pisoni, I.; Giannelli, C.; Di Cioccio, V.; Costantino, P.; Saul, A.; Martin, L. B., Production of a conjugate vaccine for Salmonella enterica serovar Typhi from Citrobacter Vi. Vaccine 2012, 30 (5), 853-61.
12. van Damme, P.; Kafeja, F.; Anemona, A.; Basile, V.; Hilbert, A. K.; De Coster, I.; Rondini, S.; Micoli, F.; Qasim Khan, R. M.; Marchetti, E.; Di Cioccio, V.; Saul, A.; Martin, L. B.; Podda, A., Safety, immunogenicity and dose ranging of a new Vi-CRM(1)(9)(7) conjugate vaccine against typhoid fever: randomized clinical testing in healthy adults. PLoS One 2011, 6 (9), e25398.
13. Bhutta, Z. A.; Capeding, M. R.; Bavdekar, A.; Marchetti, E.; Ariff, S.; Soofi, S. B.; Anemona, A.; Habib, M. A.; Alberto, E.; Juvekar, S.; Khan, R. M.; Marhaba, R.; Ali, N.; Malubay, N.; Kawade, A.; Saul, A.; Martin, L. B.; Podda, A., Immunogenicity and safety of the Vi-CRM197 conjugate vaccine against typhoid fever in adults, children, and infants in south and southeast Asia: results from two randomised, observer-blind, age de-escalation, phase 2 trials. The Lancet. Infectious diseases 2014, 14 (2), 119-29.
14. Guidelines on the quality, safety and efficacy of typhoid conjugate vaccines. WHO TRS, 987, Annex 3.
15. Lemercinier, X.; Martinez-Cabrera, I.; Jones, C., Use and validation of an NMR test for the identity and O-acetyl content of the Salmonella typhi Vi capsular polysaccharide vaccine. Biologicals 2000, 28 (1), 17-24.
16. Stone, A. L.; Szu, S. C., Application of optical properties of the Vi capsular polysaccharide for quantitation of the Vi antigen in vaccines for typhoid fever. J Clin Microbiol 1988, 26 (4), 719-25.
17. Ip, C. C.; Manam, V.; Hepler, R.; Hennessey, J. P., Jr., Carbohydrate composition analysis of bacterial polysaccharides: optimized acid hydrolysis conditions for HPAEC-PAD analysis. Analytical biochemistry 1992, 201 (2), 343-9.
18. Talaga, P.; Vialle, S.; Moreau, M., Development of a high-performance anion-exchange chromatography with pulsed-amperometric detection based quantification assay for pneumococcal polysaccharides and conjugates. Vaccine 2002, 20 (19-20), 2474-84.
19. Tsai, C. M.; Gu, X. X.; Byrd, R. A., Quantification of polysaccharide in Haemophilus influenzae type b conjugate and polysaccharide vaccines by high-performance anion-exchange chromatography with pulsed amperometric detection. Vaccine 1994, 12 (8), 700-6.
20. Ricci, S.; Bardotti, A.; D'Ascenzi, S.; Ravenscroft, N., Development of a new method for the quantitative analysis of the extracellular polysaccharide of Neisseria meningitidis serogroup A by use of high-performance anion-exchange chromatography with pulsed-amperometric detection. Vaccine 2001, 19 (15-16), 1989-97.
21. Rohrer, J. S., Vaccine Quality Ensured by High-Performance Anion-Exchange Chromatography with Pulsed Amperometric Detection. SLAS technology 2019, 2472630319890309.
22. Micoli, F.; Rondini, S.; Pisoni, I.; Proietti, D.; Berti, F.; Costantino, P.; Rappuoli, R.; Szu, S.; Saul, A.; Martin, L. B., Vi-CRM 197 as a new conjugate vaccine against Salmonella Typhi. Vaccine 2011, 29 (4), 712-20.
23. Hestrin, S., The reaction of acetylcholine and other carboxylic acid derivatives with hydroxylamine, and its analytical application. J Biol Chem 1949, 180 (1), 249-61.
24. Gerke, C.; Colucci, A. M.; Giannelli, C.; Sanzone, S.; Vitali, C. G.; Sollai, L.; Rossi, O.; Martin, L. B.; Auerbach, J.; Di Cioccio, V.; Saul, A., Production of a Shigella sonnei Vaccine Based on Generalized Modules for Membrane Antigens (GMMA), 1790GAHB. PLoS One 2015, 10 (8), e0134478.
25. Tsugita, A.; Scheffler, J. J., A rapid method for acid hydrolysis of protein with a mixture of trifluoroacetic acid and hydrochloric acid. European journal of biochemistry 1982, 124 (3), 585-8.
26. Arcuri, M.; Di Benedetto, R.; Cunningham, A. F.; Saul, A.; MacLennan, C. A.; Micoli, F., The influence of conjugation variables on the design and immunogenicity of a glycoconjugate vaccine against Salmonella Typhi. Plos One 2017, 12 (12), e0189100.
27. Jones, C., Revised structures for the capsular polysaccharides from Staphylococcus aureus Types 5 and 8, components of novel glycoconjugate vaccines. Carbohydrate research 2005, 340 (6), 1097-106.
28. Geno, K. A.; Gilbert, G. L.; Song, J. Y.; Skovsted, I. C.; Klugman, K. P.; Jones, C.; Konradsen, H. B.; Nahm, M. H., Pneumococcal Capsules and Their Types: Past, Present, and Future. Clin Microbiol Rev 2015, 28 (3), 871-99.
29. Global, regional, and national incidence, prevalence, and years lived with disability for 328 diseases and injuries for 195 countries, 1990-2016: a systematic analysis for the Global Burden of Disease Study 2016. Lancet 2017, 390 (10100), 1211-1259.
30. Mani, S.; Wierzba, T.; Walker, R. I., Status of vaccine research and development for Shigella. Vaccine 2016, 34 (26), 2887-2894.

1. A method for measuring the concentration and/or amount of one or more polysaccharide in a test sample comprising or consisting of the steps of:
a. acid hydrolysis of the test sample with hydrochloric acid and trifluoroacetic acid;
b. chromatographic separation of the hydrolysed test sample of step (a); and
c. determining the concentration and/or amount of the one or more polysaccharide based on the data generated in step (b).

2. The method of claim 1, wherein the chromatography is analytical chromatography, for example, column chromatography, gas chromatography or liquid chromatography (for example, HPLC [high-performance liquid chromatography] or HPAEC [high performance anion exchange chromatography]).

3. The method of claim 2, wherein the chromatography is HPAEC, for example, HPAEC-PED (high performance anion exchange chromatography with pulsed electrochemical detection) or HPAEC-PAD (high performance anion exchange chromatography with pulsed amperometric detection).

4. The method of claim 3, wherein the HPAEC is HPAEC-PAD.

5. The method of claim 1, wherein the polysaccharide is a bacterial polysaccharide, for example, a capsular polysaccharide or a lipopolysaccharide.

6. The method of claim 1, wherein the polysaccharide is resistant to common acid hydrolysis.

7. The method of claim 1, wherein the polysaccharide contains 2-amino uronic acid.

8. The method of claim 1, wherein the polysaccharide is selected from the group consisting of:
a. Vi capsular polysaccharide;
b. Shigella sonnei O-antigen;
c. Acinetobacter baumannii K1 capsular polysaccharide;
d. Streptococcus pneumoniae serotype 12A;
e. Streptococcus pneumoniae serotype 12F;
f. Staphylococcus aureus type 5 capsular polysaccharide;
g. Staphylococcus aureus type 8 capsular polysaccharide;
h. Enterobacterial common antigen (ECA).

9. The method of claim 1, wherein the polysaccharide is Vi capsular polysaccharide.

10. The method of claim 1, wherein the acid hydrolysis step:
a. is performed with a concentration hydrochloric acid and trifluoroacetic acid, to achieve at least about 90% monomer recovery of the test sample polysaccharide(s), for example, at least about 91%, 92%, 93%, 94%, 95%, 96%, 97%, 98%, 99% or 100% monomer recovery of the test sample polysaccharide(s); and/or
b. results in no monomer degradation or substantially no monomer degradation; and/or
c. does not result in a HPAEC-PAD peak common to polysaccharides containing different 2-amino uronic acids.

11-12. (canceled)

13. The method of claim 1, wherein the hydrochloric acid and trifluoroacetic acid of acid hydrolysis step (a) are used in admixture.

14. The method of claim 1, wherein the hydrochloric acid and trifluoroacetic acid are mixed to a concentration of:
a. 7M to 10 M HCl (for example, 8M to 10M, 8M to 9M, or 8M HCl); and
b. 5% to 30% v/v TFA (for example, 10% to 25%, 10% to 20% or 10% TFA v/v TCA),
optionally wherein the acid hydrolysis step is not performed with <6M HCl.

15. The method of claim 1, wherein the acid hydrolysis step is performed:
a. at 72.0° C. to 85.0° C., for example, 75.0° C. to 82.5° C., 77.5° C. to 82.5° C., or about 80° C.; and/or
b. performed for 3.5 to 6.0 hours, for example, 4.0 to 6.0 hours, 4.0 to 5.5 hours, 4.0 to 5.0 hours or about 4.5 hours.

16. (canceled)

17. The method of claim 3, wherein the HPAEC-PAD step is run for ≤30 minutes, for example, ≤25 minutes, ≤20 minutes, ≤19 minutes, ≤18 minutes, ≤17 minutes, ≤16 minutes, ≤15 minutes, ≤14 minutes, ≤13 minutes, ≤11 minutes, ≤10 minutes or ≤9 minutes.

18. The method of claim 1, wherein, prior to acid hydrolysis, the test sample is desalted and/or buffer exchanged, for example, by dialysis or gel filtration chromatography.

19. The method of claim 1, wherein the method comprises or consists of the steps of:
i. optionally, desalting a test sample by gel filtration chromatography.
ii. mixing the test sample with TFA-HCl solution at a ratio of 0.3:1 v/v (for example, mixed by vortexing);
iii. heating the mixture of step (ii) at about 80° C. for about 4.5 hours;
iv. cooling the mixture of step (iii) to room temperature;
v. evaporating the mixture of step (iv) (for example, by nitrogen flush, such that the test sample is felly desiccated [e.g., at least about 99% desiccated w/w, preferably about 99.5%, about 99.6%, about 99.7%, about 99.8%, about 99.9%, about 99.99% desiccated w/w]);
vi. dissolving the mixture of step (v) in water (for example, 300 ml of water and dissolved by, for example, vortexing);
vii. filtering the mixture of step (vi) through a 0.2 μm filter;
viii. performing HPAEC-PAD on the mixture of step (vii);
ix. determining the amount and/or concentration of the or a polysaccharide in the test sample.

20. The method of claim 1, wherein, in step (c), the concentration and/or amount of the one or more polysaccharide is determined by comparison with chromatographic measurements of one or more control sample.

21. The method according to claim 20, wherein:
a. the one or more control samples comprise predetermined concentrations and/or amounts of a polysaccharide to be measured in the test sample; and/or
b. the one or more control sample(s) is(are) subjected to the same sample preparation, acid hydrolysis and chromatographic steps as the test sample, or
c. sample preparation, acid hydrolysis and chromatographic steps of the test sample are performed concurrently with, or consecutive to, the sample preparation, acid hydrolysis and chromatographic steps of the one or more control sample; and/or
d. a sufficient number and/or concentration range of control samples of differing concentrations are used to provide a line of best fit, for example, a line of best fit that results in (a) a significant regression model, (b) a non-significant lack of fit, and/or (c) residuals normally distributed without the need for data transformation; and/or
e. the following concentration of polysaccharide in the one or more control sample is 0.05 to 15 μg/mL, for example, about 0.05, about 0.08, about 0.10, about 0.15, about 0.16, about 0.31, about 0.62, about 1.25, about 2.5, about 5 and about 10 μg/mL; and/or
f. the concentration of polysaccharide in the one or more control sample is 5.0 to 10 μg/mL; and/or
g. the amount of polysaccharide in the test sample is determined by comparison with one or more control samples, for example, using a standard curve generated using control sample data; and/or
h. the chromatographic run order of the test and/or control samples is randomised; and/or
i. the test and control samples are run in triplicate, quadruplet or quintuplet repeats.

22.-29. (canceled)

30. A test sample prepared using the acid hydrolysis step defined in claim 1.

31. A kit for performing the method defined in claim 1 comprising (a) hydrochloric acid, (b) trifluoroacetic acid, and (c) optionally, instructions for use.
